(19) United States
(12) Patent Application Publication
(10) Pub. No.: US 2007/0153085 A1
(43) Pub. Date: Jul. 5, 2007

(54) Rear-view mirror with front and rear bidirectional lens and screen for displaying images

(76) Inventor: Ching-Shan Chang, Xinzhuang City (TW)

Correspondence Address: J.C. Patents, Inc., Suite 250, 4 Venture, Irvine, CA, 92618, US

(21) Appl. No.: 11/400,075

(22) Filed: Apr. 6, 2006

(30) Foreign Application Priority Data
Jan. 2, 2006 (TW) 95100055

(51) Int. Cl. H04N 7/18

(52) U.S. Cl. 348/148

(57) ABSTRACT

A rear-view mirror with a front and rear bidirectional lens and a screen for displaying images is provided, which includes a mirror body, an image-capturing unit, and an image-displaying unit. The image-capturing unit is disposed in the mirror body and has a first lens and a second lens being shown on the mirror body, wherein the first lens is suitable for capturing the front image of the car; and the second lens is suitable for capturing the rear image of the car. The image-displaying unit mentioned is disposed in the mirror body. Additionally, the image-displaying unit has a display shown on the mirror body or hidden at the backside of the mirror body. The display is suitable for displaying the image captured by the first lens and/or the second lens.

### CROSS-REFERENCE TO RELATED APPLICATION

This application claims the priority benefit of Taiwan application serial no. 95100055, filed on Jan. 2, 2006. All disclosure of the Taiwan application is incorporated herein by reference.

### BACKGROUND OF THE INVENTION

1. Field of Invention

The present invention relates to a rear-view mirror, and more particularly to a rear-view mirror with recording and displaying functions.

2. Description of Related Art

In modern life, the automobile has become the most commonly used transportation tool. With the development of science and technology, the interior of the automobile can be provided with various equipments according to the driver's requirements. Common equipments are video devices, speed measuring radars, and global positioning systems (GPSs), etc., which are all used for providing required information to the driver.

For driving safety, the driver has to pay attention to the situation in front of the car, and the situation at the back of the car can be known from the rear-view mirror. However, the driver may be easily distracted due to the sound or light signals generated by various equipments inside the car, thus influencing driving safety. Also, when operating the above equipments, the driver tends to move his/her sight away from the driving direction, which is very dangerous for the driver. Obviously, this requires improvement.

Furthermore, the condition of the vehicle itself is also closely associated with driving safety. However, the driver can only obtain a part of the limited information from the instrument board, such that the driver only grasps a general idea of the vehicle condition based on the information shown on the instrument board, and cannot further obtain the detailed situation of the whole vehicle; thus, the driver is not in full control of whether or not tiny parts of the vehicle are required to be replaced or are due for maintenance and repair.

### SUMMARY OF THE INVENTION

An object of the present invention is to provide a rear-view mirror with a front and rear bidirectional lens and a screen for displaying images. The rear-view is integrated with various equipments inside the vehicle, which is convenient for the driver to operate, thus improving driving safety. On the other hand, the rear-view mirror with a front and rear bidirectional lens and a screen for displaying images can be used to receive and store the information data of any on board diagnostics (OBD) system protocol by connecting with the car via the diagnostics link connector (DLC), thus monitoring the whole operation of the car, such as, engine speed, car speed, water temperature, load, air flow, feedback control value, oxygen sensor monitoring test, driving computer information, catalytic converter and heating function, misfire monitor, fuel evaporation system, secondary air-in-taking system, fuel combustion system, oxygen sensor monitoring, exhaust gas recirculation (EGR) system, positive crankcase ventilation (PCV) system, and other elements related to gas exhaust controlling. Therefore, not only the whole operation of the car is monitored, gas consumption, oxygen sensor monitoring, and driving computer information of the car are known to the driver, but also the car is made much healthier, such that a large amount of maintenance costs of the car can be saved.

In order to achieve the above or other objects, the present invention provides a rear-view mirror with a front and rear bidirectional lens and a screen for displaying images, which comprises a mirror body, an image-capturing unit, and an image-displaying unit. The mirror body is disposed at a windshield in the front of a car for a driver to obtain a rear image of the car by observing the mirror body. Moreover, the image-capturing unit is disposed in the mirror body, wherein the image-capturing unit has a first lens and a second lens shown on the mirror body, and the first lens is suitable for capturing a front image of the car, and the second lens is suitable for capturing the rear image of the car. The above image-displaying unit is disposed in the mirror body. The image-displaying unit has a display shown on the mirror body or hidden at the back side of the mirror body, which is suitable for displaying the front image of the car captured by the first lens and/or the rear image of the car captured by the second lens.

In one embodiment of the present invention, the above rear-view mirror with a front and rear bidirectional lens and a screen for displaying images further comprises a data storage unit disposed in the mirror body, which has a built-in memory and a hard disk. The built-in memory is suitable for storing an image-capturing program and/or an image-displaying program; the image-capturing program directs the first lens and/or the second lens to capture images and to store the images into the hard disk; the image-displaying program can further direct the display to display image data stored in the hard disk.

In one embodiment of the present invention, the above data storage unit can further include an expansion slot and an external memory card, wherein the expansion slot is disposed on the mirror body, and the external memory card is plugged in the expansion slot for storing the image data captured by the first lens and/or the second lens or the image data stored in the hard disk.

In one embodiment of the present invention, the above data storage unit can further include a transmission slot and a cassette magnetic disk. The transmission slot is disposed on the mirror body, and the cassette magnetic disk is plugged in the transmission slot for storing the image data captured by the first lens and/or the second lens or the image data stored in the hard disk.

In one embodiment of the present invention, the above rear-view mirror with a front and rear bidirectional lens and a screen for displaying images can further comprise a prompt unit disposed in the mirror body.

In one embodiment of the present invention, the above prompt unit can include a GPS.

In one embodiment of the present invention, the above prompt unit can include a speed measuring radar.

In one embodiment of the present invention, the above speed measuring radar can further include a button shown on the mirror body used for turning on or turning off the speed measuring radar.

The rear-view mirror with a front and rear bidirectional lens and a screen for displaying images provided by the present invention can record and/or display the front image, the rear image, and the inner image of the vehicle due to the disposition of the image-capturing unit and the image-displaying unit. Moreover, the images captured by the image-capturing unit can be stored in the data storage unit and transmitted to the outside for being used by other multimedia devices. The rear-view mirror with a front and rear bidirectional lens and a screen for displaying images provided by the present invention can be integrated with various equipments, and the rear-view mirror with a front and rear bidirectional lens and a screen for displaying images is disposed at the windshield in the front of the car, such that the driver can operate the equipments integrated onto the rear-view mirror with a front and rear bidirectional lens and a screen for displaying images without moving his/her sight away from the driving direction, and thus the driving safety can be further improved.

In order to make the aforementioned and other objects, features, and advantages of the present invention more comprehensible, preferred embodiments accompanied with appended drawings are described in detail below.

### BRIEF DESCRIPTION OF THE DRAWINGS

FIG. 1 is a schematic view of a part of the interior of the car.

FIG. 2A is an elevation view of a rear-view mirror with a front and rear bidirectional lens and a screen for displaying images provided by the present invention.

FIG. 2B is a top view of the rear-view mirror with a front and rear bidirectional lens and a screen for displaying images provided by the present invention.

FIG. 2C is a bottom view of the rear-view mirror with a front and rear bidirectional lens and a screen for displaying images provided by the present invention.

FIG. 3A is a schematic view of a multiple-directions rotatable lens of the present invention and FIG. 3B is an operation diagram of a multiple-directions rotatable lens in the FIG. 3A.

FIG. 4 is a systematic block diagram of the rear-view mirror with a front and rear bidirectional lens and a screen for displaying images of the present invention.

### DESCRIPTION OF EMBODIMENTS

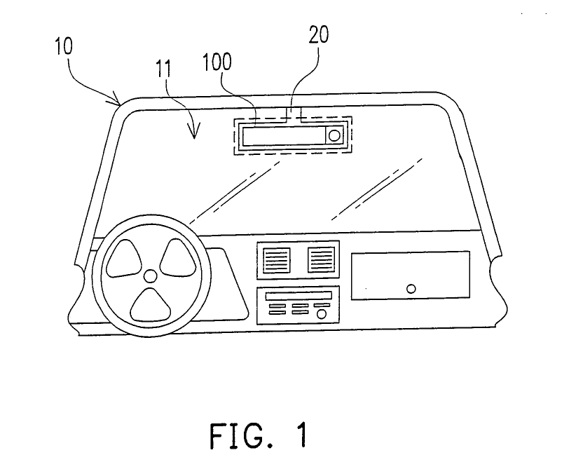

FIG. 1 is a schematic view of a part of the interior of the car. Referring to FIG. 1, the rear-view mirror 100 with a front and rear bidirectional lens and a screen for displaying images provided by the present invention can be disposed within the car 10, such that the driver will know the rear image of the car 10 by observing the rear-view mirror. Generally speaking, the rear-view mirror 100 with a front and rear bidirectional lens and a screen for displaying images can be fastened near the windshield 11 inside the car through a base 20. The driver can adjust the rear-view mirror 100 with a front and rear bidirectional lens and a screen for displaying images into a position that is convenient for observation by rotating the base 20 according to the individual requirements.

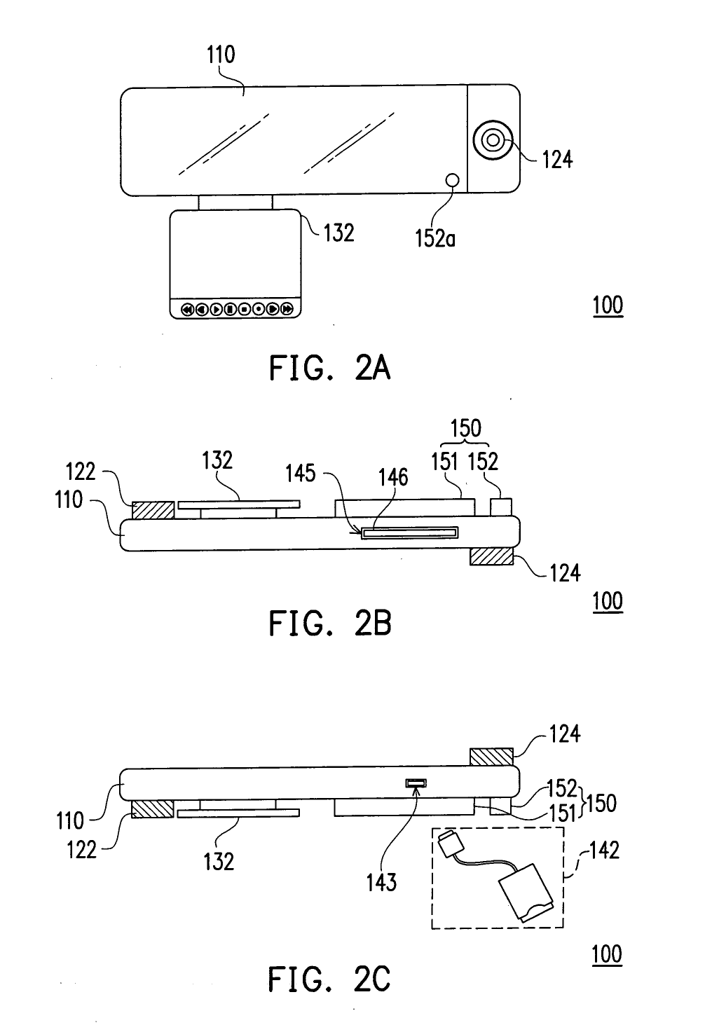

FIG. 2A is an elevation view of a rear-view mirror with a front and rear bidirectional lens and a screen for displaying images provided by the present invention. FIG. 2B is a top view of the rear-view mirror with a front and rear bidirectional lens and a screen for displaying images provided by the present invention. Referring to FIGS. 2A and 2B, the rear-view mirror 100 with a front and rear bidirectional lens and a screen for displaying images includes a mirror body 110, an image-capturing unit, (FIGS. 2A and 2B only depict a first lens 122 and a second lens 124 shown on the mirror body 110), and an image-displaying unit 130 (FIGS. 2A and 2B only depict a display 132 shown under the mirror body 110). The mirror body 110 is disposed at the windshield 11 in the front of the car 10 and is located on the direction of the driver's sight, such that the driver can obtain the situation at the back seat of the car 10 and the rear road situation of the car 10 by observing the mirror body 110.

It should be noted that the image-capturing unit, except the first lens 122 and the second lens 124, of the present invention is disposed within the mirror body 110. Of course, the disposed position of the image-capturing unit within the mirror body 110 is not restricted, and any appropriate position within the mirror body 110 is acceptable. The two lenses 122, 124 of the image-capturing unit can capture the front image, the rear image, and the back seat image of the car 10, and records the static or dynamic images digitally, for example. Of course, other ways of recording images also can be used, which is not limited herein.

More particularly, the image-capturing unit has a first lens 122 and a second lens 124, which are shown on the mirror body 110. The first lens 122 and a second lens 124 can be a common charge-coupled device (CCD). The first lens 122 is suitable for capturing the front image of the car 10, and the second lens 124 is suitable for capturing the rear image and the backseat image of the car 10.

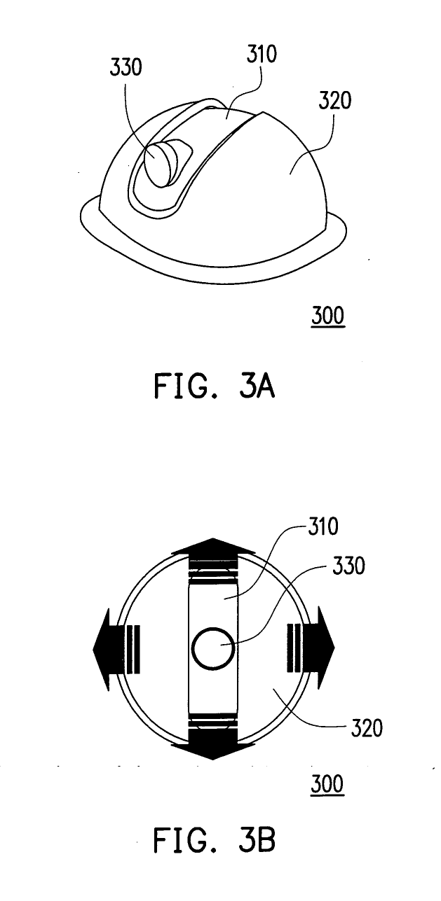

FIG. 3A is a schematic view of a multiple-directions rotatable lens of the present invention and FIG. 3B is an operation diagram of a multiple-directions rotatable lens in the FIG. 3A. The multiple-directions rotatable lens 300 includes a first rotatable seat 310 and a second rotatable seat 320, and a lens 330 is disposed on the first rotatable seat 310. The first and second rotatable seats 310 and 320 are adopted for rotating the lens 330 along a vertical visual angle and a horizontal visual angle respectively so that the lens 330 may capture image in any vertical or horizontal visual angle by employing the first and second rotatable seats 310 and 320 as shown in FIG. 3B. Thus, the multiple-directions rotatable lens 300 is not only employed for capturing images from a single direction but may also be employed for capturing images in a full range of visual angles, such as an eye. A user may, manually or via electrical control, adjust the direction of the lens 330 such as up, down, left or right for better performance according to different requirements.

When passengers on the backseat have a business meeting or discuss on important issues in the car 10, the whole procedures can be recorded through the second lens 124 of the image-capturing unit to be used as backup data. Besides, the taxi driver can record the face and behavior of a passenger through the second lens 124 of the image-capturing unit when he/she is carrying a passenger, such that in case that there is a quarrel between the driver and the passenger, the whole situation can be recovered by the images recorded through the second lens 124 of the image-capturing unit.

On the other hand, since the whole driving process can be recorded by the image-capturing unit 120, when a traffic accident happens to the driver, the situations before and after the whole traffic accident can be traced back by using the images recorded through the image-capturing unit 120. Similarly, if a traffic accident happens to a car that is in front of or behind the car 10 of the driver, the accident also can be recorded by the image-capturing unit 120 of the present invention, thus the driver can provide the recorded image files to the police to facilitate the case.

Of course, the images recorded by both lenses 122, 124 of the above image-capturing unit can be played directly in the car by the display 132 of the image-displaying unit provided by the present invention, or temporarily stored without being displayed, which will be described below in detail. Specifically, the image-displaying unit is disposed in the mirror body 110. The image-displaying unit 130 is provided with a display 132, for example, a liquid crystal display (TFT-LCD), an organic light emitting display (OLED), or other displaying devices suitable for displaying images. The main function of the display 132 is to display the images recorded by the two lenses 122, 124 of the image-capturing unit. Of course, the display 132 can be combined with other multimedia devices for displaying other entertainment images, which is not particularly limited herein.

More particularly, the display 132 can be shown on the mirror body 110 or hidden at the backside of the mirror body 110. The display 132 can be integrated with the mirror body 110 via a slide base or a slide rail or a movable mechanism. When the user intends to watch the images recorded by the two lenses 122, 124 of the image-capturing unit, the display 132 can be shown on the mirror body 110 for the convenience of the watcher. When the user does not need to observe via the display 132, the display 132 can be accommodated behind the mirror body 110.

It should be especially mentioned herein that the display 132 can be used to selectively display the front image of the car 10 captured by the first lens 122 or the rear image of the car 10 captured by the second lens 124. Moreover, the display 132 also can be used to simultaneously display the front image of the car 10 captured by the first lens 122 and the rear image of the car 10 captured by the second lens 124. Generally, the display 132 has various displaying functions such as slow play, step play, fast forward/reverse, or the function of searching specific sections, and the like.

As described above, the rear-view mirror 100 with a front and rear bidirectional lens and a screen for displaying images provided by the present invention has been generally described. Of course, the rear-view mirror 100 with a front and rear bidirectional lens and a screen for displaying images provided by the present invention can be integrated with other electrical devices based on the requirements of the user, which is described in details below.

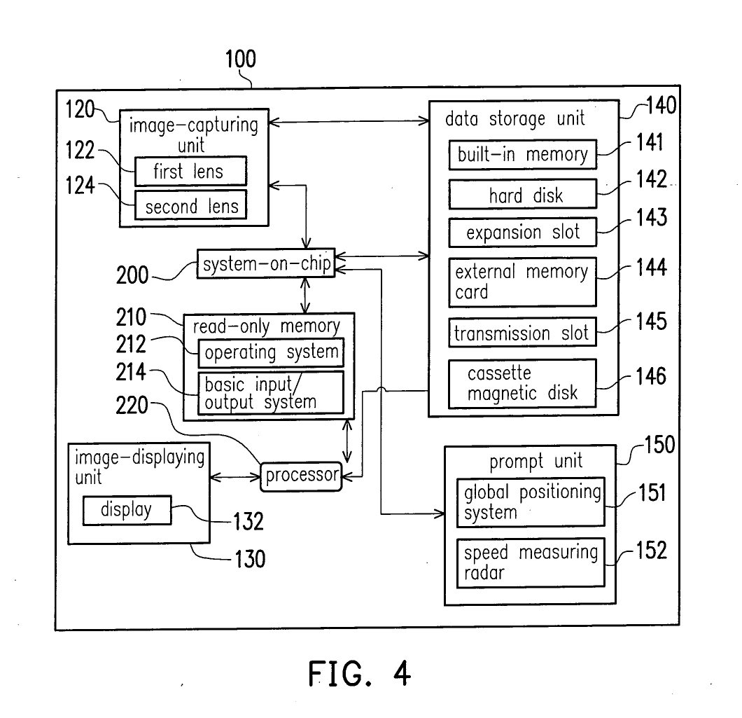

FIG. 4 is a systematic block diagram of the rear-view mirror with a front and rear bidirectional lens and a screen for displaying images of the present invention. Referring to FIG. 3, in order to store the images recorded by the capturing unit 120, the rear-view mirror 100 with a front and rear bidirectional lens and a screen for displaying images provided by the present invention further includes a data storage unit 140, which is assembled together with the mirror body 110. The data storage unit 140 has a built-in memory 141 and a hard disk 142.

Particularly, the built-in memory 141 can be used to store the image-capturing program and/or the image-displaying program. The image-capturing program can be used to direct the first lens 122 and/or the second lens 124 to capture images and then store the images into the hard disk 142. Moreover, the image-displaying program can be used to direct the display 132 to display the image data stored in the hard disk 142, and to display the image data in different ways according to the requirements of the user. Of course, the driver can select to display the images captured by the first lens 122 and the second lens 124 simultaneously or separately on the display 132 so as to grasp the situation around the car 10.

It should be especially mentioned herein that the above operation flow can be handled through a system-on-chip (SOC) 200, and certainly, other suitable chips also can be used, which is not particularly limited herein. For example, the image data recorded by the image-capturing unit 120 will be directly stored in the hard disk 142 of the data storage unit 140. The image-capturing program in the built-in memory 141 can be controlled by SOC 200 and a firmware stored in the read-only memory (ROM) 210 to direct the first lens 122 and/or the second lens 124 of the image-capturing unit 120 to capture images and store the images into the hard disk 142, wherein the firmware comprises an operating system (OS) 212 and a basic input/output system (BIOS) 214.

Moreover, through the SOC 200 and the firmware stored in the ROM 210, a processor 220 is directed to decode the image data of the data storage unit 140, and the image-displaying program stored in the data storage unit 140 is used to direct the image-displaying unit 130 to display images.

FIG. 2C is a bottom view of the rear-view mirror with a front and rear bidirectional lens and a screen for displaying images provided by the present invention. Referring to FIG. 2C, in order to transmit the images recorded by the above capturing unit 120 to the outside to be used by other multimedia devices, e.g., a desktop computer or a notebook computer etc., the data storage unit 140 of the present invention can further include an expansion slot 143 and an external memory card 144. In addition, the expansion slot 143 is disposed on the mirror body 110, and can be preferably disposed, e.g., on the upper edge or lower edge of the mirror body 110, which is not particularly limited herein.

Specifically, the expansion slot 143 is, for example, a universal serial bus (USB), and the external memory card 144 can be plugged therein for storing the image data captured by the first lens 122 and/or the second lens 124, or the image data stored in the hard disk 142.

It should be especially mentioned herein that the file type of the image data stored in the hard disk 142 can be the standard JPEG file compression format, AVI file compression format, or other common file formats. Thus, the image data in the hard disk 142 can be stored in the external memory card 144 by the user for being carried along and provided to other multimedia devices to be displayed.

Of course, the method for storing images is not limited to the one described herein. The data storage unit 140 of the present invention can further include a transmission slot 145 and a cassette magnetic disk (MD) 146 as shown in FIG. 2B. Wherein, the transmission slot 145 is disposed on the mirror body 110; and the cassette magnetic disk 146 is plugged in the transmission slot 145 for storing the image data captured by the first lens 122 and/or the second lens 124, or the image data stored in the hard disk 142. With the cassette magnetic disk 146, the user can also take the image data along with him/her, such that the image data can be provided to other multimedia devices for being displayed.

Furthermore, since the vehicle exhaust emission standard has become increasingly strict in recent years, vehicles are generally provided with an on-board diagnostics (OBD) system connected to various sensors in the vehicle for detecting the elements related to exhaust emission, for example, fuel combustion device or exhaust gas recirculation (EGR) system. When the amount of the exhaust gas exceeds the control range, the warning light on the instrument board will shine to clearly indicate where the problem lies. The above situation detection data of the vehicle can be transmitted to the outside through a diagnostics link connector (DLC) disposed within the vehicle.

The data storage unit 140 of the present invention can be electrically connected to the DLC, such that the above situation detection data of the vehicle can be stored in the data storage unit 140. Moreover, the situation detection data of the vehicle can be displayed on the display 132 via the image-displaying unit 130, such that the driver or maintainer can clearly grasp the situation of the vehicle. Of course, the OBD system also can provide further vehicle situation data to the data storage unit 140, for example, the data about catalytic converter, misfire monitor, fuel evaporation system, fuel combustion system, or driving records. Particularly, the above driving records including, for example, data of swerving, accelerating, braking, gear shifting, enabling the direction lights or rain wiper in the whole driving process can be stored in the data storage unit 140 for later retrieval and use.

The rear-view mirror 100 with a front and rear bidirectional lens and a screen for displaying images provide by the present invention also can have various common vehicle equipments being integrated therein. Thus, when driving, the driver can operate each of the equipments integrated in the rear-view mirror 100 without leaving his/her sight away from the driving direction. Therefore, driving safety can be improved.

Particularly, the rear-view mirror 100 with a front and rear bidirectional lens and a screen for displaying images provided by the present invention can further include a prompt unit 150 combined into the mirror body 110. The prompt unit 150 can give a prompt to the driver through sounds or lights. The prompt unit 150 can include a GPS 151, which can be used to prompt the driver about the driving courses by displaying on the display 132. Generally speaking, the GPS 151 has the functions of intelligent voice prompt, humanized turn by turn indication, automatical course planning, and provision of an accurate electronic map. All the data mentioned above can be stored in the data storage unit 140 and periodically updated through a built-in map updating program.

Of course, the above prompt unit 150 can also include a speed measuring radar 152 disposed at the same side with the first lens 122 for conveniently receiving signals. The speed measuring radar 152 further includes a button 152a shown on the mirror body 110, which is suitable for the driver to turn on or turn off the speed measuring radar 152. Generally speaking, the speed measuring radar 152 has a speech prompt function to remind the driver of the road speed limits so as to keep a safe driving speed.

To sum up, the rear-view mirror with a front and rear bidirectional lens and a screen for displaying images provided by the present invention at least has the following advantages:

1. The rear-view mirror with front and rear bidirectional lens and a screen for displaying images provided by the present invention can be used to record the front image, the rear image, and the inner image of the car due to the using of the image-capturing unit, and the images can be played by the image-displaying unit. Therefore, images of the meeting held by passengers in the car or images of the situation around the car during driving can be recorded as backup data for later use.

2. The rear-view mirror with a front and rear bidirectional lens and a screen for displaying images provided by the present invention can be integrated with various equipments, and the rear-view mirror is disposed at the windshield in the front of the car. Therefore, the driver can operate the equipments integrated with the rear-view mirror with a front and rear bidirectional lens and a screen for displaying images without moving his/her sight away from the driving direction, and thus the driving safety can be dramatically improved.

3. The images captured by the image-capturing unit of the present invention can be stored in the data storage unit and transmitted to an external memory card or a cassette magnetic disk for being carried along with the user. In addition, the images also can be provided to other multimedia devices for being displayed, which is quite convenient.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A rear-view mirror with a front and rear bidirectional lens and a screen for displaying images, comprising:
a mirror body disposed at a windshield in the front of a car, for a driver to obtain a rear image of the car by observing the mirror body;
an image-capturing unit disposed in the mirror body, having a first lens and a second lens shown on the mirror body, wherein the first lens is used to capture a front image of the car, and the second lens is used to capture the rear image of the car; and
an image-displaying unit disposed in the mirror body, having a display shown on the mirror body or hidden at the backside of the mirror body, wherein the display is used to display the front image of the car captured by the first lens and/or the rear image of the car captured by the second lens.

2. The rear-view mirror with a front and rear bidirectional lens and a screen for displaying images as claimed in claim 1 further comprising a data storage unit disposed in the mirror body, having a built-in memory and a hard disk, wherein the built-in memory is used to store an image-capturing program and/or an image-displaying program; the image-capturing program is used to direct the first lens and/or the second lens to capture images and store the images to the hard disk; the image-displaying program is used to further direct the display to display the image data stored in the hard disk.

3. The rear-view mirror with a front and rear bidirectional lens and a screen for displaying images as claimed in claim 2, wherein the data storage unit further includes an expansion slot and an external memory card; the expansion slot is disposed on the mirror body; the external memory card is plugged in the expansion slot for storing the image data captured by the first lens and/or the second lens or the image data stored in the hard disk.

4. The rear-view mirror with a front and rear bidirectional lens and a screen for displaying images as claimed in claim 2, wherein the data storage unit further includes a transmission slot and a cassette magnetic disk; the transmission slot is disposed on the mirror body; the cassette magnetic disk is plugged in the transmission slot for storing the image data captured by the first lens and/or the second lens or the image data stored in the hard disk.

5. The rear-view mirror with a front and rear bidirectional lens and a screen for displaying images as claimed in claim 1 further comprising a prompt unit disposed in the mirror body.

6. The rear-view mirror with a front and rear bidirectional lens and a screen for displaying images as claimed in claim 5, wherein the prompt unit includes a global positioning system (GPS).

7. The rear-view mirror with a front and rear bidirectional lens and a screen for displaying images as claimed in claim 5, wherein the prompt unit includes a speed measuring radar.

8. The rear-view mirror with a front and rear bidirectional lens and a screen for displaying images as claimed in claim 7, wherein the speed measuring radar further includes a button shown on the mirror body, which is used for turning on or turning off the speed measuring radar.

9. The rear-view mirror with a front and rear bidirectional lens and a screen for displaying images as claimed in claim 1, wherein the first lens is a multiple-direction rotatable lens.

10. The rear-view mirror with a front and rear bidirectional lens and a screen for displaying images as claimed in claim 9, wherein the multiple-directions rotatable lens comprises a first rotatable seat and a second rotatable seat, and the first lens disposed on the first rotatable seat is adopted for capturing images from a first visual angle of the first direction rotated by the first rotatable seat, and the first lens and the first rotatable seat disposed on the second rotatable seat is adopted for capturing images from a second visual angle of the first direction rotated by the second rotatable seat.

11. The rear-view mirror with a front and rear bidirectional lens and a screen for displaying images as claimed in claim 1, wherein the second lens is a multiple-directions rotatable lens.

12. The rear-view mirror with a front and rear bidirectional lens and a screen for displaying images as claimed in claim 11, wherein the multiple-direction rotatable lens comprises a first rotatable seat and a second rotatable seat, and the second lens disposed on the first rotatable seat is adopted for capturing images from a first visual angle of the second direction rotated by the first rotatable seat, and the second lens and the first rotatable seat disposed on the second rotatable seat is adopted for capturing images from a second visual angle of the second direction rotated by the second rotatable seat.
